(19) United States
(12) Patent Application Publication
(10) Pub. No.: US 2026/0225888 A1
(43) Pub. Date: Aug. 6, 2026

(54) Processing Of Phosphate Solutions

(71) Applicant: EasyMining Sweden AB, Sollentuna (SE)

(72) Inventors: Hugo ROYEN, Uppsala (SE); Yariv COHEN, Uppsala (SE)

(21) Appl. No.: 19/148,730

(22) PCT Filed: Jan. 25, 2024
(86) PCT No.: PCT/SE2024/050063

§ 371 Date: Jul. 17, 2025

(30) Foreign Application Priority Data
Jan. 27, 2023 (SE) 2350075-4

(51) Int. Cl. C01B 25/238; C01B 25/22; C01B 25/28; C01B 25/30; C01B 25/46; C02F 11/00; C02F 101/22; C02F 103/00

(52) U.S. Cl. CPC C01B 25/238; C01B 25/2212; C01B 25/28; C01B 25/305; C01B 25/46; C02F 11/004; C02F 2101/22; C02F 2103/005

(57) ABSTRACT

A method for production of pure phosphates comprises providing (S10) of a strip solution being an aqueous solution of one of monoammonium phosphate and monopotassium phosphate, loaded with stripped phosphate from a feed liquid comprising phosphoric acid contaminated by heavy metals and iron A base is added (S20) into the separated strip solution raising the pH to 2-5.5, forming of a heated solution and causing compounds comprising iron and phosphate to precipitate. A precipitant, precipitating heavy metals, is added (S30). Precipitated compounds comprising iron and phosphate and precipitated heavy metal compounds are separated (S40). The heated filtered solution is thereafter cooled off (S50) into a cooled solution, causing precipitation of phosphate compounds. The precipitated phosphate compounds are removed (S60) from the cooled solution. The cooled solution is recirculated (S70) for use as input strip solution in the stripping operation. A system for production of pure phosphates is also disclosed.

### TECHNICAL FIELD

The present technology refers in general to processing of phosphate solutions and in particular to methods and systems for production of pure phosphates from feed solutions comprising phosphoric acid contaminated by heavy metals and iron.

### BACKGROUND

Liquid-liquid extraction is a very effective way of purifying phosphoric acid produced conventionally using sulfuric acid on impure raw materials such as rock phosphate or sewage sludge ash. The phosphate may then be extracted from such a leachate. The reason for using this way is that many extractants are selective to phosphoric acid and will not extract significant amounts of metal contaminants such as Cu, Cd, Fe and Zn. However, typically, As an F may be coextracted together with P and have to be taken care of in subsequent steps.

However, the extraction of phosphoric acid from water is inefficient due to an unfavorable distribution equilibrium. This means that many extraction stages are required to reach reasonable yields, which incurs high capital and operation costs. An easy way to improve the efficiency is to add chlorides to the phosphoric acid solution to shift the distribution equilibrium to be much more favorable.

By replacing sulfuric acid with hydrochloric acids for the dissolution of the phosphorus, the Ca content of rock phosphate or sewage sludge ash will form soluble CaCl₂) instead of insoluble gypsum, resulting in a phosphoric acid solution with a high chloride concentration which improves extraction.

In the published International patent applications WO 2022/173349 A1 and WO 2022/115021 A1, processes for recovery of phosphate from sewage sludge ash and apatite, respectively, by leaching with HCl were disclosed. In these processes, the feed phosphoric acid concentration is comparatively low compared to commercial processes for purifying phosphoric acid. Despite the high chloride background this results in a comparatively dilute strip solution (<3.5 M) which is very expensive to concentrate to commercial concentrations using evaporation.

The published International patent applications WO 2013/191639 A1 and WO 2021/251891 A1 describes production of ammonium phosphates and potassium phosphates, respectively, by liquid-liquid extraction of a phosphorus-containing feed liquid. Here, phosphoric acid is extracted using a concentrated solution of MAP or MKP and then reacted with ammonia or KOH to oversaturate the solution and precipitate solid MAP or MKP. This can then be recovered by filtration instead of evaporation.

However, the addition of chlorides has a large disadvantage in that the selectivity of the phosphoric acid extraction decreases, leading to significant co-extraction of problematic impurities such as As, Cd, Cr, Cu, Fe, Ni and Zn. The allowable limits of these impurities are limited by both fertilizer regulations and by industry standards, and several of them form insoluble phosphates which will decrease the solubility of the end product below the levels desired in high-grade MAP or MKP products.

### SUMMARY

A general object is thus to find processes producing phosphate compounds with less contamination of Fe and heavy metals.

The above object is achieved by methods and devices according to the independent claims. Preferred embodiments are defined in dependent claims.

In general words, in a first aspect, a method for production of pure phosphates comprises providing a strip solution loaded with stripped phosphate. The strip solution loaded with stripped phosphate is formed by liquid-liquid extraction from a feed liquid comprising phosphoric acid contaminated by heavy metals and iron and an input strip solution. The input strip solution is an aqueous solution of one of monoammonium phosphate and monopotassium phosphate. A base is added into the strip solution loaded with stripped phosphate. Thereby a pH of the strip solution loaded with stripped phosphate is raised to a range of 2-5.5, preferably to a range 3-5 and most preferably to a range 4-5. When the input strip solution is an aqueous solution of monoammonium phosphate, the base comprises ammonia and/or ammonium salts. When the input strip solution is an aqueous solution of monopotassium phosphate, the base instead comprises potassium salts. The adding of a base is exothermic, which leads to a forming of a heated solution from the separated strip solution loaded with stripped phosphate. The adding of a base causes compounds comprising iron and phosphate to precipitate from the heated solution, thereby giving an iron-depleted heated solution. A precipitant is added to the heated solution, precipitating heavy metal compounds, and thereby forming a heavy-metal-depleted heated solution. The precipitated compounds comprising iron and phosphate and precipitated heavy metal compounds are separated from the heavy-metal-depleted heated solution, forming a heated filtered solution. The heated filtered solution is thereafter cooled off into a cooled solution. This cooling causes precipitation of phosphate compounds. When the input strip solution is an aqueous solution of monoammonium phosphate, the phosphate compounds comprise monoammonium phosphate. When the input strip solution is an aqueous solution of monopotassium phosphate, the phosphate compounds comprise monopotassium phosphate. The precipitated phosphate compounds are removed from the cooled solution. The cooled solution is recirculated after the step of removing the precipitated phosphate compounds for use as input strip solution in the liquid-liquid extraction.

In a second aspect, a system for production of pure phosphates comprises a liquid-liquid extraction arrangement, a contaminant precipitation reactor and a cooling-precipitator arrangement. The liquid-liquid extraction arrangement operates by use of a recirculated solvent. The liquid-liquid extraction arrangement has a first input for a feed liquid, a second input for an input strip solution, a first output for strip solution loaded with stripped phosphate and a second output for feed liquid depleted in phosphorous. The feed liquid comprises phosphoric acid contaminated by heavy metals and iron. The strip solution is an aqueous solution of one of monoammonium phosphate and monopotassium phosphate. The contaminant precipitation reactor has a first input connected to the first output of the liquid-liquid extraction arrangement for receiving the strip solution loaded with stripped phosphate and a second input for receiving a base. When the input strip solution is an aqueous solution of monoammonium phosphate, the base comprises ammonia or ammonium salts. When the input strip solution is an aqueous solution of monopotassium phosphate, the base comprises potassium salts. The contaminant precipitation reactor is configured for adding the base into the separated strip solution loaded with stripped phosphate, giving a pH of the strip solution in a range of 2-5.5, preferably in a range 3-5 and most preferably in a range 4-5. The adding of the base to the strip solution loaded with stripped phosphate causes an exothermic reaction, whereby a heated solution forms from the strip solution loaded with stripped phosphate. The adding of the base to the strip solution loaded with stripped phosphate further causes compounds comprising iron and phosphate to precipitate from the heated solution giving an iron-depleted heated solution. The contaminant precipitation reactor has a third input for receiving a precipitant, precipitating heavy metal compounds. The contaminant precipitation reactor is configured for adding the precipitant to the iron-depleted heated solution after the adding of the base and thereby forming a heavy-metal-depleted heated solution. The contaminant precipitation reactor comprises a solid/liquid separation equipment configured for warm separation of the precipitated compounds comprising iron and phosphate and precipitated heavy metal compounds from the heavy-metal-depleted heated solution. A heated filtered solution is thereby formed. The contaminant precipitation reactor has a first output for the filtered precipitated compounds comprising iron and phosphate and precipitated heavy metal compounds and a second output for the heated filtered solution. The cooling-precipitator arrangement has an input connected to the second output of the contaminant precipitation reactor for receiving the heated filtered solution. The cooling-precipitator arrangement comprises equipment for cooling off the heated filtered solution into a cooled solution. Thereby, precipitation of phosphate compounds is caused. When the strip solution is an aqueous solution of monoammonium phosphate, the phosphate compounds comprise monoammonium phosphate. When the strip solution is an aqueous solution of monopotassium phosphate, the phosphate compounds comprise monopotassium phosphate. The cooling-precipitator arrangement comprises a solid/liquid separator for removing the precipitated phosphate compounds from the cooled solution. The cooling-precipitator arrangement has a first output for the precipitated phosphate compounds and a second output for the cooled solution. The second output of the cooling-precipitator arrangement is connected to the second input of the liquid-liquid extraction arrangement for using the cooled solution as input strip solution in the liquid-liquid arrangement.

One advantage with the proposed technology is that monoammonium phosphate or monopotassium phosphate with very low contamination levels may be produced. Other advantages will be appreciated when reading the detailed description.

### BRIEF DESCRIPTION OF THE DRAWINGS

The invention, together with further objects and advantages thereof, may best be understood by making reference to the following description taken together with the accompanying drawings, in which:

FIG. 1 is a diagram illustrating extraction efficiency for phosphate in tributyl phosphate; and

FIG. 2 is a flow diagram of steps of an embodiment of a method for production of pure phosphates;

FIG. 3 is a diagram illustrating solubility of Fe and Al phosphates at different pH;

FIG. 4 is a diagram illustrating solubility of Fe hydroxide at different temperatures;

FIG. 5 is a diagram illustrating solubility of different metal hydroxides at different pH;

FIG. 6 is a diagram illustrating solubility of different metal sulfides at different pH; and

FIG. 7 is a schematic drawing of an embodiment of a system for production of pure phosphates.

### DETAILED DESCRIPTION

Throughout the drawings, the same reference numbers are used for similar or corresponding elements.

For a better understanding of the proposed technology, it may be useful to begin with a brief discussion of different approaches for avoiding contaminants.

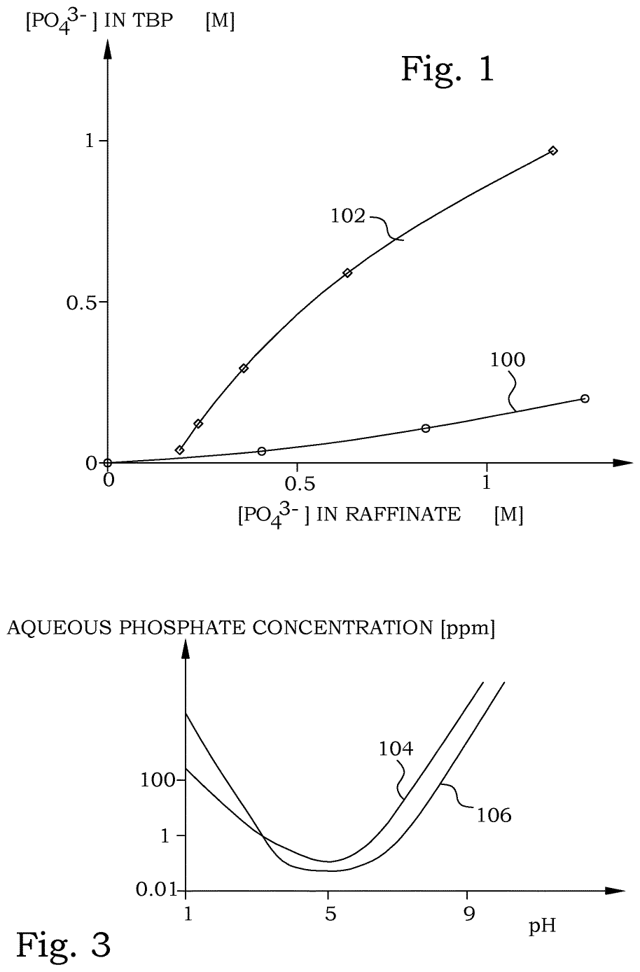

As mentioned in the background, extraction of phosphoric acid from water is inefficient due to an unfavorable distribution equilibrium. This is illustrated in FIG. 1 by extraction curves for phosphoric acid with 3M CaCl₂) (artificial leachate) and without background CaCl₂). This means that if e.g. sewage sludge ash, phosphate rock or apatite is dissolved in sulfuric acid, many contaminants are precipitated as different sulfur compounds giving a water solution with low chloride content. The contaminant precipitation is of course of benefit. However, as illustrated by the extraction curve 100, many extraction stages are required to reach reasonable yields of phosphorus extraction, which incurs high capital and operation costs.

By replacing sulfuric acid with hydrochloric acid, the Ca content of rock phosphate or sewage sludge ash will form soluble CaCl₂) instead of insoluble gypsum. This results in a phosphoric acid solution with a comparably high chloride concentration which improves extraction, e.g. according to the extraction curve 102. As mentioned in the background, despite the high chloride background a liquid-liquid extraction process may result in a comparatively dilute strip solution (<3.5 M). By using a concentrated solution of MAP or MKP as strip solution and then reacting it with ammonia or KOH to oversaturate the solution, precipitation of solid MAP or MKP may be obtained and then separated by simple filtration methods.

However, as also mentioned above, significant co-extraction of problematic impurities may result. With impurities in the stream, these will either precipitate in the stages where the pH is increased due to addition of ammonia or KOH or remain in solution and be present in the cake water of the product, and potentially as inclusions or occlusions in the formed product crystals. To reach low concentrations of impurities in the product, these must be removed from the strip solution before the product precipitates.

In order to reduce the levels of Fe, it has in prior art been suggested to remove Fe(III) either by selective extraction prior to phosphorus extraction and/or by reduction of Fe(III) to Fe(II), which is not extracted by commonly used solvents such as TBP. The efficiency of the liquid-liquid extraction solution is limited by the limited selectivity of TBP for Fe(III) compared to phosphate, while reduction to Fe(II) would require Fe(II) to be handled later in the process.

For other co-extracted impurities, the published International Patent Application WO 2022/173349 A1 suggested addition of an inorganic or organic sulfide or the use of ion exchange resins at any of several places in the process. However, practical experiments on a larger scale have shown that it would not be possible to reach the desired product quality if impurities were only removed at one of these places. Instead, several treatment steps in different parts of the process would be needed, which would be costly. In addition, the precipitation of impurities in the DAP generation step of WO 2022/173349 A1 would foul the heat exchangers and remove a major advantage of adding ammonia to a side stream.

The published International patent application WO 2022/115021 A1 suggested that Cd may be removed either by selective liquid-liquid extraction or by sulfide precipitation in the main flow or the loaded strip solution. It was further suggested that As may be removed by sulfide precipitation using either inorganic or organic sulfides, e.g. TMT-15 or Accophos 800, from either the main flow, the loaded strip solution, or the MAP solution, as long as acidic conditions, in the loaded strip solution typically having a pH of 0-1, Accophos 800 did not precipitate heavy metals such as Zn.

At low pH, the high H⁺ concentration outcompetes many metal ions, and it is known that for example the sulfides of Cd, Fe(II), Ni and Zn are still soluble at low pH. If inorganic sulfides like NaHS is used, a large part of the sulfides would form hydrogen sulfide gas, which is a safety issue and decreases the efficiency.

Also Fe could in theory be removed by sulfide precipitation. However, in order to obtain requested levels of Fe, very large amounts of sulfides are required. Tests with commercial organic precipitants shows that Accophos 800 had difficulties removing enough Zn and As from loaded MAP solutions due to competition with remaining Fe, while both NaHS and TMT-15 had difficulties removing the Zn.

According to the present technology, a more efficient way of removing both Fe and other coextracted impurities is suggested.

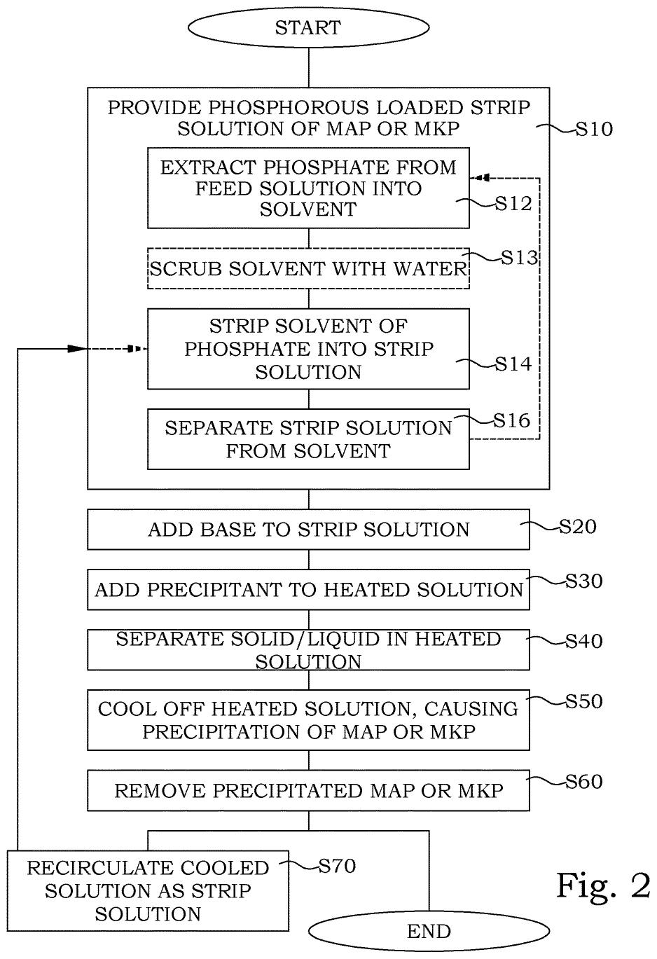

FIG. 2 is a flow diagram of steps of an embodiment of a method for production of pure phosphates. In step S10, a strip solution loaded with stripped phosphate is provided. An input strip solution is an aqueous solution of one of monoammonium phosphate and monopotassium phosphate. The input strip solution is furthermore loaded with stripped phosphate from a feed liquid comprising phosphoric acid contaminated by heavy metals and iron as obtained by liquid-liquid extraction.

In step S20, a base is added into the separated strip solution loaded with stripped phosphate. The adding is performed until it raises the pH of the strip solution loaded with stripped phosphate to be within a range of 2-5.5. Preferably, the pH is within the range 3-5 and most preferably the pH is within the range of 4-5. When the input strip solution is an aqueous solution of monoammonium phosphate, the base comprises ammonia and/or an ammonium salt. When the input strip solution is an aqueous solution of monopotassium phosphate, the base comprises potassium salts. In a preferred embodiment, and when the input strip solution is an aqueous solution of monoammonium phosphate, the base comprises ammonia and/or basic ammonium salts. More preferably, the base comprises ammonia and/or ammonium carbonate, and most preferably the base comprises ammonia. In a preferred embodiment, and when the input strip solution is an aqueous solution of monopotassium phosphate, the base comprises basic potassium salts. More preferably the base comprises potassium hydroxide and/or potassium carbonate, and most preferably the base comprises potassium hydroxide.

The chemical process being the result of the of adding a base is exothermic. Thereby, heat is generated, forming a heated solution from the separated strip solution loaded with stripped phosphate. The adding of a base also causes compounds comprising iron and phosphate to precipitate from the heated solution giving an iron-depleted heated solution. These compounds comprising iron and phosphate are typically different kinds of iron phosphates.

In step S30, a precipitant is added to the heated solution. The precipitant is active in precipitating heavy metal compounds. Thereby, a heavy-metal-depleted heated solution is formed. In step S40, the precipitated compounds comprising iron and phosphate and the precipitated heavy metal compounds are separated from the heavy-metal-depleted heated solution. The temperature is maintained at a high temperature in order to keep the phosphate compounds in solution. The separation can be performed in different ways, as such known in prior art, e.g. by warm-filtering or centrifugal-motion separation. Thereby a heated filtered solution is formed.

In step S50, the heated filtered solution is cooled off into a cooled solution. This temperature decrease causes precipitation of phosphate compounds, since the solubility decreases with decreasing temperature. When the input strip solution is an aqueous solution of monoammonium phosphate, the phosphate compounds comprise monoammonium phosphate. When the input strip solution is an aqueous solution of monopotassium phosphate, the phosphate compounds comprise monopotassium phosphate. In step S60, the precipitated phosphate compounds are removed from the cooled solution. These precipitated phosphate compounds may be the final product of the present treatment, or may be further processed. The precipitated phosphate compounds have very small levels of heavy metal contaminations. Furthermore, the precipitated phosphate compounds also comprise very small amounts of Fe. This allows for using the precipitated phosphate compounds as efficient fertilizers.

The cooled solution after the step of removing the precipitated phosphate compounds is now a saturated liquid solution of monoammonium phosphate or monopotassium phosphate. In step S70, the cooled solution is recirculated for use as input strip solution in the stripping process of the step of providing strip solution loaded with stripped phosphate.

In a preferred embodiment, as illustrated in FIG. 2, the step S10 of providing a strip solution in turn comprises a number of part steps. In step S12, phosphate is extracted from the feed liquid by a liquid-liquid extraction into a solvent. In step S14, the solvent is stripped of at least a part of the phosphate by a liquid-liquid extraction into the input strip solution. In step S16, the strip solution loaded with stripped phosphate and the solvent at least partially depleted in phosphate are separated. Preferably, the solvent at least partially depleted in phosphate is reused in the phosphate extraction process, as illustrated by the dotted arrow. The recirculation of cooled solution in step S70 is thus preferably used in step S14 as at least a part of the strip solution.

In a preferred embodiment, in particular for feed liquids comprising non-negligible amounts of calcium, these calcium ions may be, at least to a part, removed during the extraction process. To this end, in step S13, the solvent is scrubbed with water. This occurs after the step S12 of extracting phosphate but before the step S14 of stripping the solvent.

As was illustrated in FIG. 1, a high chloride background in the feed liquid improved the extraction of phosphate ions into the solvent. It is thus considered that in a preferred embodiment, the feed liquid is a phosphoric acid solution with a chloride concentration above 2 M. Preferably, the chloride concentration is above 3 M.

In a preferred embodiment, the solvent comprises tributyl phosphate (TBP). However, other types of solvents are also operable, see e.g. the published International patent applications WO 2022/173349 A1 and WO 2022/115021 A1.

One important component in the present technology is to cause precipitation of contaminants in two sequential steps while keeping phosphate ions in solution. This thus gives rise to a purified phosphate solution. In a first precipitation step, caused by the step S20, in which a base is added to the strip solution, the pH of the strip solution is increased. The strip solution as achieved from the stripping of the solvent has typically a pH between 0 and 1. Typical phosphate ion concentrations are less than 5 M and for most setups below 3.5 M. This solution also comprise iron. Increasing the pH of the strip solution can precipitate several impurities as hydroxides. For instance, upon increasing the pH, the solubility of iron hydroxide as well as of iron phosphate, i.e. strengite, rapidly decreases. The same behaviour is seen also for Al, where the aluminium phosphate, i.e. variscite, solubility decreases upon increasing pH. This is valid at least up to a pH of 5.

FIG. 3 illustrates a diagram illustrating the solubility of strengite by curve 104 and the solubility of variscite by curve 106 as a function of pH. Already at a pH of 2, the solubility has decreased so much that much of the Fe and Al already has precipitated. Above pH 3 and even more so at pH above 4, the solubility becomes very low. When the base is added in an amount sufficient for turning all phosphoric acid into either monoammonium phosphate or monopotassium phosphate, the pH typically ends up below pH 5.5, and more often below pH 5. The pH typically rises above pH 4 in the vast majority of cases. There is thus a first synergetic effect in that the amount of base added for creating monoammonium phosphate or monopotassium phosphate at the same time gives a pH that is suitable for precipitation of Fe and Al compounds. At the pH where all phosphoric acid has reacted to form MAP or MKP, most of the Fe will precipitate as either iron hydroxide or iron phosphate. i.e. strengite, and much of the Al will precipitate as aluminium phosphate, i.e. variscite.

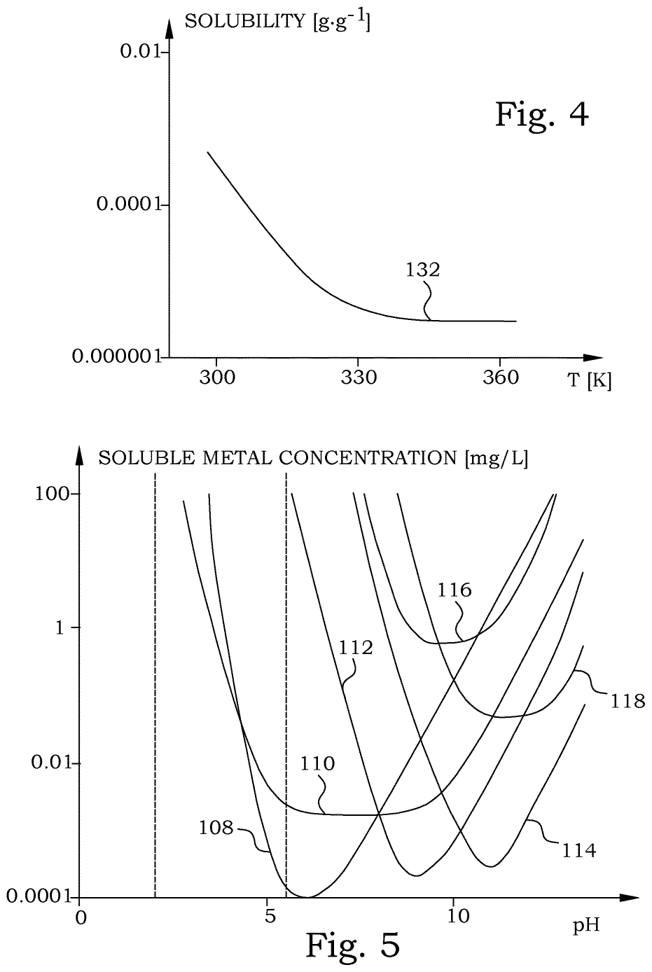

The neutralization reaction between the phosphoric acid and the base is an exothermic reaction. Adding KOH or, especially, ammonia will thus generate heat. This means that an increase of the pH of the strip solution also is accompanied by a temperature increase. For most substances, solubility typically increase with increased temperature. However, iron phosphate is an exception. FIG. 4 is a diagram illustrating the solubility of iron phosphate as a function of temperature by curve 132. The concentration of H₃PO₄ in the solution is 1.13 wt %. Thus, when the temperature increases, the solubility of iron phosphate decreases, which increases the amount of precipitated iron compounds, driving the remaining iron concentrations within the solution to even lower levels.

At the same time, the increasing temperature leads to a higher solubility for MAP and MKP, respectively. The increased temperature thereby reduces any possible losses by precipitation of MAP or MKP. In a preferred embodiment, the final temperature is above 40° C. In other words, the step of adding a base into the separated strip solution loaded with stripped phosphate comprises maintaining a temperature of the heated solution above 40° C.

In prior art production of fertilizers from phosphoric acid, in order to increase the yield, one typically starts with phosphoric acid concentrations far above the concentrations that are feasible in the present type of systems. In such conventional processes run with high phosphoric acid concentration the produced heat is enough to bring the solution above the boiling point. Many processes consequently do all or part of the addition of the base at elevated pressure and use the excess heat to contribute to the drying process. Therefore, pressure chambers are typically used for enabling operation at temperatures above 100° C.

However, since the phosphoric acid concentration in the present systems using liquid-liquid exchange techniques is much lower, the final temperature after adding the base typically is maintained below 80° C., which enables operations without pressure chambers, and in most cases extra cooling is not necessary. Using a loaded MAP strip solution derived from pilot-scale tests at steady state using a sewage sludge ash feedstock, ammonization to pH 3.8 increased the temperature by 40-42° C. and ammonization to pH 4.4 increased the temperature by 48-52° C. Using an artificial loaded MKP strip solution, which comprises about 1.2 M phosphoric acid, 221 g/L MKP, and adding a slight excess of dry KOH, ending at a final pH 4.8 increased the temperature by 23° C.

In other words, in one embodiment the step of adding a base into the separated strip solution loaded with stripped phosphate comprises maintaining a temperature of the heated solution below 80° C.

As mentioned above, the equilibrium temperature depends on the amount of added base. Therefore in one embodiment, the maintaining of a temperature of the heated solution is performed by selecting an amount of base in dependence of a phosphoric acid concentration in the strip solution to give an exothermic energy at equilibrium that is lower than an energy required to heat the strip solution to 80° C.

If the phosphoric acid concentration is too high, and the amount of base required for producing MAP or MKP may give a too high temperature, it is of course also possible to actively cool the strip solution in order to maintain the temperature low enough. In other words, the maintaining of a temperature of the heated solution may be performed by measuring a temperature of the strip solution and cooling the heated solution if needed to maintain the heated solution below 80° C.

The apparent disadvantage of having a relatively low phosphoric acid concentration in the loaded strip solution now surprisingly has turned into an advantage instead. The low concentration suits perfectly for providing a pH range and a temperature range that is very efficient in removing Fe from the solution. Therefore, in a preferred embodiment, the strip solution has a phosphoric acid concentration below 5 M. In an even more preferred embodiment, the strip solution has a phosphoric acid concentration below 3.5 M.

As mentioned above, Fe and Al, if present, are efficiently removed as phosphates and/or hydroxides by the combined pH increase and temperature increase. However, heavy metal phosphates have high solubility and so does most heavy metal hydroxides, at least in the above discussed pH ranges. FIG. 5 illustrates a number of solubility curves for different selected metal hydroxides. As can be seen, only Fe, curve 108, and Al, curve 110, have low enough solubilities for pH<5.5 for possibly giving rise to any precipitation. However, all remaining contaminants remains in solution. Curve 112 corresponds to Cu, curve 114 corresponds to Ni, curve 116 corresponds to Zn and curve 118 corresponds to Cd. This means that several regulated and potentially toxic elements such as As, Cd, Cu, Cr, Ni and Zn will remain highly soluble at this pH.

However, since Fe at this stage is almost completely removed from the solution, precipitation agents that typically experience competition by precipitates of Fe before or in combination with other ions, can now be used. These impurities can thereby be removed by addition of selective precipitants, with NaHS as one typical example.

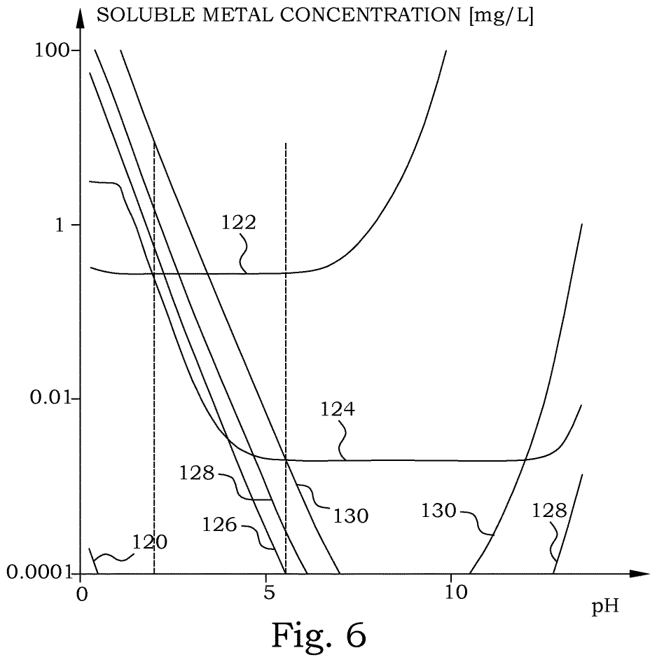

FIG. 6 is a diagram illustrating the pH dependence of the solubility of different metal sulfides. Curve 120 corresponds to Cu, curve 122 corresponds to As, curve 124 corresponds to Pb, curve 126 corresponds to Cd, curve 128 corresponds to Ni and curve 130 corresponds to Zn. Cr also forms compounds with sulfide with low solubility. Using a precipitant comprising sulfide in different forms therefore seems to be a good way to remove such elements from the solution, even in the pH ranges between 2 and 5.5. In other words, the method is operational for removing contamination, where the contaminating heavy metals are at least one of As, Cd, Cr, Cu, Ni, Pb and Zn.

Other precipitants, or a combination of precipitants, could of course be used, if their properties or combination of properties allow them to remove the problematic impurities present in a given feedstock. Some examples are other inorganic sulfides, organic sulfides, polysulfides, other organic sulfur-based precipitants such as Accophos 800, phosphines, chelating compounds such as oxalate, ion exchange resins, and any other compound which preferentially binds to the impurities present. Preferably, the precipitant comprises a dithiophosphinate.

At the pH where all phosphoric acid has reacted to form MAP or MKP, which is about 4-5, at least the sulfides of Cu, Cd, Ni and Zn are insoluble. The higher pH also decreases the problem with any possible sulfide gas formation.

It is possible to filter each precipitate separately or to filter them together. Filtering both at the same time is generally favorable since it decreases the number of process steps and improves both the capture and the filterability of small, precipitated particles, such as inorganic sulfides.

One goal of the current process is to allow for a process using hydrochloric acid to recover phosphate from impure sources such as phosphate minerals (for example calcium phosphate, apatite, struvite or vivianite) or phosphate-containing waste (for example sewage sludge ash, meat and bone ash, manure ash, dried sewage sludge, fire retardant powder, fire extinguisher powder and LiFePO₄ battery waste). This phosphate is then efficiently recovered as phosphoric acid by liquid-liquid extraction due to the high chloride background. The comparatively dilute phosphoric acid strip solution is then processed to produce MAP or MKP without the need for evaporation in a way that separates impurities such as As, Cd, Cu, Fe and Zn with a minimal use of chemicals such as precipitants.

Table 1 below first, in the middle column, shows the product quality in a pilot scale batch test of a variant of a process similar to what was described in the published international patent application WO 2022/173349 A1, where a commercial precipitant was added to a side stream of the MAP filtrate before it is ammoniated to produce DAP. The side stream was filtered after the ammonization. The feedstock for the test was sewage sludge ash from a process using an iron-based coagulant and several cycles were run with recirculation of solutions to allow the process to reach a steady state.

Table 1 then shows, the right column, results from experiments where the here above suggested process was tested in laboratory scale on a loaded MAP stripping solution from the pilot scale tests. The improvements are striking.

TABLE 1
Quality of final product for prior art test approaches
and for a test based on the present technology.

| | Side stream | Suggested |
|---|---|---|
| Method | purification | process |
| Solubility (w %) | 90.5-95.6 | 97.9-98.8 |
| Fe in product (g/kg) | 7.5-15.6 | 0.13-1.7 |
| Cd in product (mg/kg) | 1.5-2.4 | Negligible |
| Cu in product (mg/kg) | 400-1000 | Negligible |
| Pb in product (mg/kg) | 38-67 | Negligible |

The solubility figures are presented for only a pH increase. This means that since sulfur compounds likely also precipitate many remaining Fe ions, the figures after addition of a precipitant would increase the solubility further. By the term “negligible” is understood that the contamination levels were reduced to concentrations below the detection limit.

In one embodiment, the strip solution is an aqueous solution of monoammonium phosphate. The base to be added thereby comprises ammonia and/or an ammonium salt, preferably ammonia and/or a basic ammonium salt, more preferably ammonia and/or ammonium carbonate and most preferably ammonia. The result of this is then that the phosphate compounds comprise monoammonium phosphate.

In another embodiment, the strip solution is an aqueous solution of monopotassium phosphate. The base to be added thereby comprise a potassium salt, preferably a basic potassium salt, more preferably potassium hydroxide and/or potassium carbonate and most preferably potassium hydroxide. The result of this is then that the phosphate compounds comprise monopotassium phosphate.

As mentioned above, one goal of the current process is to allow for a process using hydrochloric acid to recover phosphate from impure sources. Therefore, in one embodiment, the method for production of pure phosphates comprises the further step of dissolving a start material comprising phosphorus in hydrochloric acid providing a leachate. Undissolved residues are then removed from the leachate, whereby the leachate is used as at least a part of the feed liquid.

In some embodiments, the start material comprises at least one of sewage sludge ash and rock phosphate.

In one embodiment, the start material comprises rock phosphate. The contaminating heavy metals then typically comprises at least As and/or Cd.

In one embodiment, the start material comprises sewage sludge ash. The contaminating heavy metals then typically comprises at least Cu.

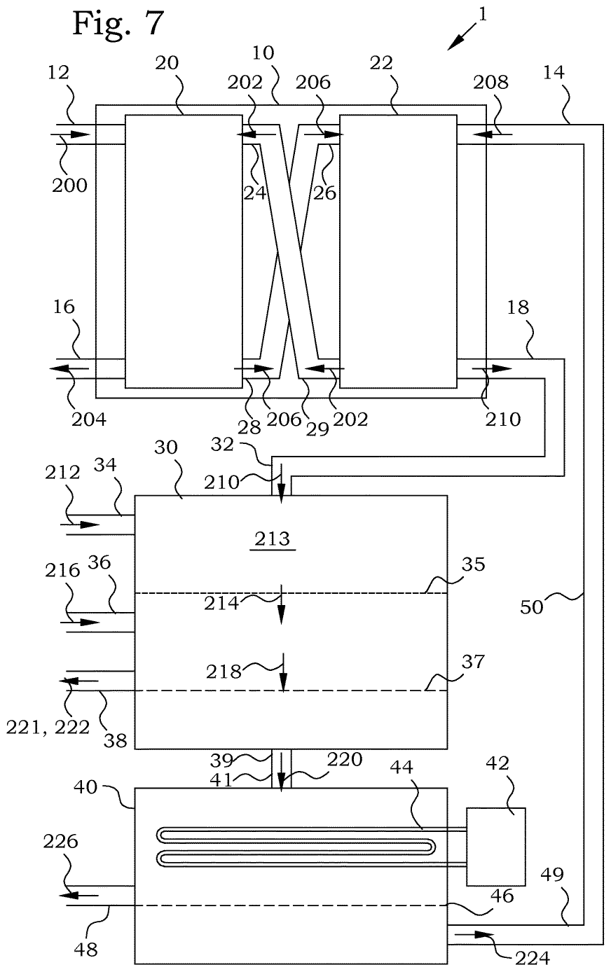

FIG. 7 illustrates schematically an embodiment of a system 1 for production of pure phosphates. A liquid-liquid extraction arrangement 10 makes use of a recirculated solvent 202, 206. The liquid-liquid extraction arrangement 10 has a first input 12 for a feed liquid 200. The feed liquid 200 comprises phosphoric acid contaminated by heavy metals and iron. A second input 14 is arranged for input of an input strip solution 208. The input strip solution 208 is an aqueous solution of one of monoammonium phosphate and monopotassium phosphate. A first output 18 is provided for strip solution loaded with stripped phosphate 210. A second output 16 is provided for feed liquid depleted in phosphorous 204.

In one embodiment, the liquid-liquid extraction arrangement 10 comprises an extraction unit 20 in which the feed liquid 200 from the first input 12 of the liquid-liquid extraction arrangement 10 is contacted by a solvent 202 provided by an extraction unit input 24. The solvent may be of different kinds, being essentially non-soluble in water and having affinity for phosphate. In a preferred embodiment, the solvent comprises tributyl phosphate. Phosphate ions will thereby be extracted from the feed liquid 200 into the solvent 202, thereby forming the feed liquid depleted in phosphorous 204 and a solvent loaded with phosphate 206, outputted by an extraction unit output 28. The liquid-liquid extraction arrangement 10 further comprises a stripping unit 22 in which the solvent loaded with phosphate 206, provided by a stripping unit input 26 connected to the extraction unit output 28, is contacted with the input strip solution 208 from the second input 14 of the liquid-liquid extraction arrangement 10. Phosphate ions will thereby be stripped from the solvent 206 into the input strip solution 208, thereby forming the strip solution loaded with stripped phosphate 210 and a solvent depleted in phosphate. The solvent depleted in phosphate is recirculated by a stripping unit output 29 as input solvent 202 to the extraction unit 20.

According to the embodiment of FIG. 1, the system 1 for production of pure phosphates further comprises a contaminant precipitation reactor 30. The contaminant precipitation reactor 30 has a first input 32 connected to the first output 18 of the liquid-liquid extraction arrangement 10 for receiving the strip solution loaded with stripped phosphate 210 and a second input 34 for receiving a base 212. The base 212 comprises ammonia and/or an ammonium salt when the input strip solution 208 is an aqueous solution of monoammonium phosphate and the base 212 comprises potassium salts when the input strip solution 208 is an aqueous solution of monopotassium phosphate. The contaminant precipitation reactor is configured for adding the base 212 into the separated strip solution loaded with stripped phosphate 210, giving a pH of the strip solution loaded with stripped phosphate 210 to a range of 2-5.5, preferably to a range 3-5 and most preferably to a range 4-5. The adding of the base 212 to the strip solution loaded with stripped phosphate 210 causes an exothermic reaction. Thereby, a heated solution 213 forms from the strip solution loaded with stripped phosphate 210, and further causes compounds comprising iron and phosphate 221 to precipitate from the heated solution 213 giving an iron-depleted heated solution 214.

The contaminant precipitation reactor 30 has furthermore a third input 36 connected for receiving a precipitant 216, precipitating heavy metal compounds 222. The contaminant precipitation reactor 30 is configured for adding the precipitant 36 to the heated solution after the adding of the base 34 and thereby forming a heavy-metal-depleted heated solution 218. This timing of the addition of the precipitants is illustrated as a dashed line 35 in the figure. This can be achieved by e.g. having different compartments in the contaminant precipitation reactor 30, where the base addition is performed in one compartment and the iron-depleted heated solution 214 is moved into a subsequent compartment in the contaminant precipitation reactor 30 for addition of the precipitant 216.

Alternatively, the addition of the base 212 and the addition of the pre precipitant 216 can be performed in the same compartment, but successively in time.

The contaminant precipitation reactor 30 further comprises a solid/liquid separation equipment 37. The solid/liquid separation equipment 37 is configured for warm separation of the precipitated compounds comprising iron and phosphate 221 and precipitated heavy metal compounds 222 from the heavy-metal-depleted heated solution 218, forming a heated filtered solution 220. The solid/liquid separation equipment may in different embodiment for instance be a warm-filtering equipment or a centrifugal separator. The contaminant precipitation reactor 30 has a first output 38 for the filtered precipitated compounds comprising iron and phosphate 221 and precipitated heavy metal compounds 222 and a second output 39 for the heated filtered solution 220.

The system 1 for production of pure phosphates further comprises a cooling-precipitator arrangement 40. The cooling-precipitator arrangement 40 has an input 41 connected to the second output 39 of the contaminant precipitation reactor 30 for receiving heated filtered solution 220. The cooling-precipitator arrangement 40 comprises equipment 42 for cooling off the heated filtered solution 220 into a cooled solution 224, causing precipitation of phosphate compounds 226. The phosphate compounds 226 comprise monoammonium phosphate when the strip solution 208 is an aqueous solution of monoammonium phosphate and the phosphate compounds 226 comprise monopotassium phosphate when the strip solution 208 is an aqueous solution of monopotassium phosphate. The cooling-precipitator arrangement 40 comprises a solid/liquid separator 46 for removing the precipitated phosphate compounds 226 from the cooled solution 224. The cooling-precipitator arrangement 40 has a first output 48 for the precipitated phosphate compounds 226 and a second output 49 for the cooled solution 224.

The equipment 42 for cooling off the heated filtered solution 220 can be of many different kinds. The illustration indicates the provision of cooling pipes 44 within the compartment of the cooling-precipitator arrangement 40. However, other cooling approaches, such as, but not limited to, bubbling of cold gas, electrically driven cold plates etc. are also applicable. Preferably, there is a cooling control unit 42 keeping track on that the temperature of the cooled solution 224 reaches a sufficiently low level for causing precipitation. Also the solid/liquid separator 46 can be of many different kinds. The illustration indicates a filter solution. However, alternative methods, such as, but not limited to, e.g, methods based on centrifugal motion are also applicable.

There are many cooling-precipitator techniques available, as such, in prior art, which are also applicable with this chemical system. Different kinds of batch crystallizers may be used. Surface-cooled crystallizers, Oslo surface-cooled crystallizers or scraped-surface crystallizers are examples of prior-art techniques that may be used in the present context. Double-pipe scraped-surface crystallizers, also known as Votator or Armstrong crystallizer is also applicable. Applicable prior art equipment for cooling crystallization can also be found in e.g. the published Chinese patent application CN 105731407 A or the published Chinese utility models CN 203048601 U, CN 209679546 U or CN 203196371 U.

The second output 49 of the cooling-precipitator arrangement 40 is connected to the second input 14 of the liquid-liquid extraction arrangement 10 for using the cooled solution 224 as input strip solution 208 in the stripping process of the liquid-liquid extraction arrangement 10.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1.-22. (canceled)

23. A method for production of pure phosphates, comprising the steps of:
providing, from a feed liquid comprising phosphoric acid contaminated by heavy metals and iron and an input strip solution, being an aqueous solution of one of monoammonium phosphate and monopotassium phosphate, a strip solution loaded with stripped phosphate by liquid-liquid extraction;
adding a base into said strip solution loaded with stripped phosphate, thereby raising a pH of said strip solution loaded with stripped phosphate to a range of 2-5.5, preferably to a range 3-5 and most preferably to a range 4-5;
said base comprising at least one of ammonia and ammonium salts when said input strip solution is an aqueous solution of monoammonium phosphate and said base comprising potassium salts when said input strip solution is an aqueous solution of monopotassium phosphate;
said step of adding a base being exothermic, thereby forming a heated solution from said strip solution loaded with stripped phosphate;
said step of adding a base causing compounds comprising iron and phosphate to precipitate from said heated solution giving an iron-depleted heated solution;
adding a precipitant to said iron-depleted heated solution, precipitating heavy metal compounds, and thereby forming a heavy-metal-depleted heated solution;
separating of said precipitated compounds comprising iron and phosphate and precipitated heavy metal compounds from said heavy-metal-depleted heated solution, forming a heated filtered solution;
cooling off said heated filtered solution into a cooled solution, causing precipitation of phosphate compounds;
said phosphate compounds comprising monoammonium phosphate when said input strip solution is an aqueous solution of monoammonium phosphate and said phosphate compounds comprising monopotassium phosphate when said input strip solution is an aqueous solution of monopotassium phosphate;
removing said precipitated phosphate compounds from said cooled solution;
recirculating said cooled solution after said step of removing said precipitated phosphate compounds for use as input strip solution in liquid-liquid extraction.

24. The method according to claim 23, wherein said step of providing a strip solution loaded with stripped phosphate in turn comprises:
extracting phosphate from said feed liquid by liquid-liquid extraction into a solvent, forming a solvent loaded with phosphate;
stripping said solvent loaded with phosphate of at least a part of said phosphate by a liquid-liquid extraction into said input strip solution, forming a strip solution loaded with stripped phosphate;
separating said strip solution loaded with stripped phosphate and said solvent at least partially depleted in phosphate.

25. The method according to claim 24, wherein said solvent comprises tributyl phosphate.

26. The method according to claim 24, wherein said feed liquid comprises calcium ions, wherein said method comprises the further step of:
scrubbing said solvent loaded with phosphate with water after said step of extracting phosphate but before said step of stripping said solvent.

27. The method according to claim 23, wherein said precipitant is selected as at least one of:
inorganic sulfides,
organic sulfides,
polysulfides,
organic sulfur-based precipitants,
phosphines,
chelating compounds such as oxalate, and
ion exchange resins.

28. The method according to claim 27, wherein said precipitant comprises a dithiophosphinate.

29. The method according to claim 23, wherein said step of adding a base into said separated strip solution loaded with stripped phosphate comprises maintaining a temperature of said heated solution below 80° C.

30. The method according to claim 29, wherein said maintaining a temperature of said heated solution is performed by selecting an amount of base in dependence of a phosphoric acid concentration in said strip solution loaded with stripped phosphate to give an exothermic energy at equilibrium that is lower than an energy required to heat said strip solution loaded with stripped phosphate to 80° C.

31. The method according to claim 29, wherein said maintaining a temperature of said heated solution is performed by measuring a temperature of said strip solution loaded with stripped phosphate and cooling said heated solution if needed to maintain said heated solution below 80° C.

32. The method according to claim 23, wherein said step of adding a base into said separated strip solution loaded with stripped phosphate comprises maintaining a temperature of said heated solution above 40° C.

33. The method according to claim 23, wherein said base comprising at least one of ammonia and basic ammonium salts, preferably at least one of ammonia and ammonium carbonate, more preferably ammonia, when said input strip solution is an aqueous solution of monoammonium phosphate and said base comprising basic potassium salts, preferably at least one of potassium hydroxide and potassium carbonate, more preferably potassium hydroxide, when said input strip solution is an aqueous solution of monopotassium phosphate.

34. The method according to claim 23, wherein said strip solution loaded with stripped phosphate has a phosphoric acid concentration below 5 M.

35. The method according to claim 34, wherein said strip solution loaded with stripped phosphate has a phosphoric acid concentration below 3.5 M.

36. The method according to claim 23, wherein said contaminating heavy metals are at least one of: As, Cd, Cr, Cu, Ni, Pb and Zn.

37. The method according to claim 23, wherein said feed liquid is a phosphoric acid solution with a chloride concentration above 2 M, preferably above 3 M.

38. The method according to claim 23, comprising the further steps of:
dissolving a start material comprising phosphorus in hydrochloric acid providing a leachate, and
removing undissolved residues from said leachate, whereby said leachate is used as at least a part of said feed liquid.

39. The method according to claim 38, wherein said start material comprises at least one of sewage sludge ash and rock phosphate.

40. The method according to claim 23, wherein said input strip solution is an aqueous solution of monoammonium phosphate, said base comprising at least one of ammonia and ammonium salts and said phosphate compounds comprise monoammonium phosphate.

41. The method according to claim 23, wherein said input strip solution is an aqueous solution of monopotassium phosphate, said base comprising potassium salts and said phosphate compounds comprise monopotassium phosphate.

42. A system for production of pure phosphates, comprising:
a liquid-liquid extraction arrangement by use of a recirculated solvent, said liquid-liquid extraction arrangement having a first input for a feed liquid, a second input for an input strip solution, a first output for strip solution loaded with stripped phosphate and a second output for feed liquid depleted in phosphorous;
said feed liquid comprising phosphoric acid contaminated by heavy metals and iron;
said strip solution being an aqueous solution of one of monoammonium phosphate and monopotassium phosphate;
a contaminant precipitation reactor, having a first input connected to said first output of said liquid-liquid extraction arrangement for receiving said strip solution loaded with stripped phosphate and a second input for receiving a base;
said base comprising at least one of ammonia and ammonium salts when said input strip solution is an aqueous solution of monoammonium phosphate and said base comprising potassium salts when said input strip solution is an aqueous solution of monopotassium phosphate;
said contaminant precipitation reactor being configured for adding said base into said separated strip solution loaded with stripped phosphate, giving a pH of said strip solution to a range of 2-5.5, preferably to a range 3-5 and most preferably to a range 4-5;
said adding of said base to said strip solution loaded with stripped phosphate causing an exothermic reaction, whereby a heated solution forms from said strip solution loaded with stripped phosphate, and further causing compounds comprising iron and phosphate to precipitate from said heated solution giving an iron-depleted heated solution;
wherein said contaminant precipitation reactor has a third input for receiving a precipitant, precipitating heavy metal compounds, wherein said contaminant precipitation reactor is configured for adding said precipitant to said iron-depleted heated solution after said adding of said base and thereby forming a heavy-metal-depleted heated solution;
wherein said contaminant precipitation reactor comprises a solid/liquid separation equipment configured for warm separation of said precipitated compounds comprising iron and phosphate and precipitated heavy metal compounds from said heavy-metal-depleted heated solution, forming a heated filtered solution;
wherein said contaminant precipitation reactor having a first output for said filtered precipitated compounds comprising iron and phosphate and precipitated heavy metal compounds and a second output for said heated filtered solution; and
a cooling-precipitator arrangement, having an input connected to said second output of said contaminant precipitation reactor for receiving said heated filtered solution;
said cooling-precipitator arrangement comprising equipment for cooling off said heated filtered solution into a cooled solution, causing precipitation of phosphate compounds;
said phosphate compounds comprising monoammonium phosphate when said strip solution is an aqueous solution of monoammonium phosphate and said phosphate compounds comprising monopotassium phosphate when said strip solution is an aqueous solution of monopotassium phosphate;
said cooling-precipitator arrangement comprising a solid/liquid separator for removing said precipitated phosphate compounds from said cooled solution;
said cooling-precipitator arrangement having a first output for said precipitated phosphate compounds and a second output for said cooled solution;
said second output of said cooling-precipitator arrangement being connected to said second input of said liquid-liquid extraction arrangement for using said cooled solution as input strip solution in said liquid-liquid extraction arrangement.
